(19) United States
(12) Patent Application Publication
(10) Pub. No.: US 2014/0327258 A1
(43) Pub. Date: Nov. 6, 2014

(54) Bucket with Adjustable Lifting Assembly

(71) Applicants: Tim Ring, Pittsburgh, PA (US); Fred Baraky, Pittsburgh, PA (US)

(72) Inventors: Tim Ring, Pittsburgh, PA (US); Fred Baraky, Pittsburgh, PA (US)

(21) Appl. No.: 14/266,126

(22) Filed: Apr. 30, 2014

Related U.S. Application Data
(60) Provisional application No. 61/818,157, filed on May 1, 2013.

(51) Int. Cl. B65G 7/12; B65D 25/28

(52) U.S. Cl. CPC B65G 7/12; B65D 25/28
USPC 294/31.2

(57) ABSTRACT

Provided is a bucket with an adjustable lifting assembly. The bucket includes an open top end, a closed bottom end, and an upstanding side wall having a perimeter. The bucket further includes a pivotally attached bail handle near the top end, and an adjustable lifting assembly that encircles the side wall. The lifting assembly includes an adjustable strap system and an annular handle attached thereto. The strap system tightly hugs the perimeter of the side wall while the annular handle is separated by a space. The lifting assembly is adapted to slideably mount onto a desired location along the height of the bucket so a user can move the lifting assembly up and down. In this way, the present invention provides a user with multiple locations for achieving a firm grip on the bucket, thereby facilitating the user with lifting or carrying the bucket.

### CROSS REFERENCE RELATED APPLICATION

This application claims the benefit of U.S. Provisional Application No. 61/818,157 filed on May 1, 2013. The above identified patent application is herein incorporated by reference in its entirety to provide continuity of disclosure.

### BACKGROUND OF THE INVENTION

### Field of the Invention

The present invention relates to a bucket with an adjustable lifting assembly. More specifically, the present invention pertains to a bucket with an adjustable lifting assembly that can be secured to various locations along the height of the bucket. In this way, the present invention allows for ease of lifting various objects placed within the bucket.

Back pain is one of the most common ailments brought on by injury, or misalignment of the spine. It can be a dull muscle ache in the lower back or a severe, sharp pain that affects a person's ability to bend over or stand up straight. Most often, back pain results from strained muscles and ligaments that surround the spine due to sudden movements or poor body mechanics while lifting heavy objects.

Lifting heavy objects can put stress on a person's back and spine. Accordingly, it is important to lift heavy loads by bending at the hips and knees to squat down to the load, keeping the load close to the body, and straightening the legs to lift. This is particularly important for people who regularly lift heavy objects. For example, many workers carry heavy objects in buckets. While conventional buckets provide bail handles, these handles are not comfortable to use when carrying heavy objects. Additionally, conventional buckets do not provide suitable places for an individual to place his or her hands when lifting the bucket from a squat position.

The present invention is a bucket with an adjustable lifting assembly. The device comprises a bucket having a bail handle pivotally attached on top, and an adjustable lifting assembly extending around the circumference of the bucket. The adjustable lifting assembly includes a strap that is attached to an annular handle. The lifting assembly can be moved up and down along the height of the bucket as needed. In this way, the lifting assembly provides a convenient secondary location for grasping and emptying the bucket. The present invention is ideal for use in homes, workshops, and other similar venues.

The primary advantage of the present invention is not only its disposition of the handles, but more specifically the adjustable feature associated with the strap. The strap allows a user to adjust the circumference of the lifting assembly so that the assembly can be secured to various locations along the height of the bucket. In this way, the lifting assembly may be positioned where it is most comfortable to an individual user. Additionally, the lifting assembly may be used with buckets of different sizes, increasing versatility to the user.

### DESCRIPTION OF THE PRIOR ART

Devices have been disclosed in the prior art that relate to container lifting apparatuses. These include devices that have been patented and published in patent application publications. Some of these devices include a ring extending around the circumference of the bucket that provides a secondary location for grasping and emptying a bucket. These devices, however, do not include an adjustable lifting assembly that includes a strap system that mounts an annular handle at various locations along the height of the bucket. The following is a list of devices deemed most relevant to the present disclosure, which are herein described for the purposes of highlighting and differentiating the unique aspects of the present invention, and further highlighting the drawbacks existing in the prior art.

For example, U.S. Pat. No. 7,399,017 to Lasseigne discloses a bucket lifting device for facilitating lifting and tipping of a bucket to empty the contents of the bucket. The bucket lifting device comprises a round sleeve having a hollow middle portion for receiving a bottom end of the bucket. The sleeve is constructed to encircle a portion of the bucket, and the sleeve includes a handle that is secured at a point along the perimeter of the sleeve. While the Lasseigne device provides a handle that facilitates lifting of a bucket, Lasseigne fails to disclose a handle that encircles the bucket. The present invention comprises a lifting device having a handle that encircles the bucket. In this way, a user can grab the handle at various locations along the perimeter of the bucket. Additionally, the handle of the present invention is adapted to allow a user to grab the handle with one or both hands, thereby facilitating the lifting of the bucket.

Similarly, U.S. Pat. No. 2,967,071 to Deschene a handle clamp comprising a round frame that is adapted to be fitted over various articles having a generally cylindrical shape. The frame comprises a handle that is disposed along the perimeter of the frame, wherein the handle is positioned perpendicular to the frame. Unlike the present invention, the device of Deschene is not adjustable. In this way, the Deschene device is limited for use with articles having certain dimensions. The present invention provides an adjustable strap system that includes allows a user to change the circumference of the lifting assembly. In this way, the present invention is adapted for use with buckets of various circumferences, increasing versatility to the user.

Another device, U.S. Pat. No. 5,967,362 to Corbin discloses a pair of lifting supports for garbage cans. The lifting supports include an open upper portion, a lower portion, and a hollow middle portion for receiving a garbage can therethrough. The lifting supports further include a side wall that extends downward at an angle from the open upper portion. In operation, the lifting supports are positioned near the top and bottom of the garbage can. To tilt or lift the garbage can, a user grabs the side wall with tips of his or her fingers. Because the user can grip the side wall with only tips of his or her fingers, the Corbin device does not provide a handle that is suitable for lifting heavy weight. Additionally, the Corbin device is not adjustable, whereas the present invention comprises an adjustable lifting assembly with a handle that provides a more comfortable and secure grip to the user.

U.S. Pat. No. 7,284,777 to Kraemer discloses a bucket lifting apparatus that includes a vertical rod having an upper and a lower end. The upper end of the rod comprises a first handle that is perpendicular to the vertical rod, and the lower end of the rod comprises a second handle that is parallel to the vertical rod. The bucket lifting apparatus further includes a first and second U-shaped members that are secured to the lower end and a substantial midpoint of the vertical rod. Each of the U-shaped members includes a strap system for securing a bucket. While Kraemer provides an adjustable lifting apparatus for use with various types of buckets, Kraemer fails to disclose a handle that encircles the perimeter of the bucket on which it is attached. The present invention comprises a lifting assembly that includes a strap system and a handle that encircles the bucket at various locations along its height. Accordingly, the present handle allows a user to position his or her hand in various locations along the perimeter of the bucket.

Finally, U.S. Pat. No. 4,045,069 to Fife discloses a bucket holder adapted for use with a paint can. The bucket holder comprises a horizontal upper strap that is connected to a horizontal lower strap via a first and second vertical straps that are parallel to one another. The vertical straps are separated by a space in which a wooden handle and a metal handle are attached. The wooden handle is pivotally attached so that it may be used to tilt the paint can. The metal handle is secured so that it may be used to hold the paint can during use. While the Fife device provides one pivotally attached handle and one fixedly attached handle, the disposition of the pivotally attached wooden handle does not allow a user to carry a bucket in an upright position. The present invention comprises a bucket with a handle that is attached near an open top portion of the bucket. The handle comprises two terminal ends that are pivotally attached to opposing sides of the open top portion. In this way, the user can grab the handle so that the handle is positioned directly above the open top portion, thereby keeping the bucket in an upright position.

These prior art devices have several known drawbacks. The prior art fails to disclose a bucket with an adjustable lifting assembly that encircles the bucket. The present bucket includes a bail handle that is pivotally attached to the top portion of the bucket so as to allow a user to carry the bucket in an upright position. The adjustable lifting assembly includes a strap system that mounts an annular handle at various locations along the height of the bucket. The annular handle allows the user to position one or both hands along the perimeter of the bucket to facilitate lifting heavier weight. It is therefore submitted that the present invention substantially diverges in design elements from the prior art, which overcomes the disadvantages of the prior art devices, and consequently it is clear that there is a need in the art for an improvement to existing container lifting apparatuses. In this regard the instant invention substantially fulfills these needs.

### SUMMARY OF THE INVENTION

In view of the foregoing disadvantages inherent in the known types of container lifting apparatuses now present in the prior art, the present invention provides a new bucket with an adjustable lifting assembly wherein the same can be utilized for increasing the ease of lifting buckets.

It is therefore an object of the present invention to provide a new and improved bucket with an adjustable lifting assembly that has all of the advantages of the prior art and none of the disadvantages.

It is another object of the present invention to provide a new and improved bucket with an adjustable lifting assembly having a bucket with a pivotally attached bail handle that may be used in conjunction with an annular handle that encircles the perimeter of the bucket.

Another object of the present invention is to provide a new and improved bucket with an adjustable lifting assembly having a strap system that mounts an annular handle on various locations along the height of a bucket.

Yet another object of the present invention is to provide a new and improved bucket with an adjustable lifting assembly that reduces the stress on a user's back and spine by providing handles near the top and the base of the bucket.

Still yet another object of the present invention is to provide a new and improved bucket with an adjustable lifting assembly that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and in manner in which it may be made and used may be better understood after a review of the following description, taken in connection with the accompanying drawings wherein like numeral annotations are provided throughout.

FIG. 1 shows a front perspective view of the bucket with an adjustable lifting assembly present invention.

FIG. 2 shows a close up view of the adjustable lifting assembly of the present invention.

### DETAILED DESCRIPTION OF THE INVENTION

Reference is made herein to the attached drawings. Like reference numerals are used throughout the drawings to depict like or similar elements of the bucket with an adjustable lifting assembly. For the purposes of presenting a brief and clear description of the present invention, the preferred embodiment will be discussed as used for utilized for increasing the ease of lifting buckets. The figures are intended for representative purposes only and should not be considered to be limiting in any respect.

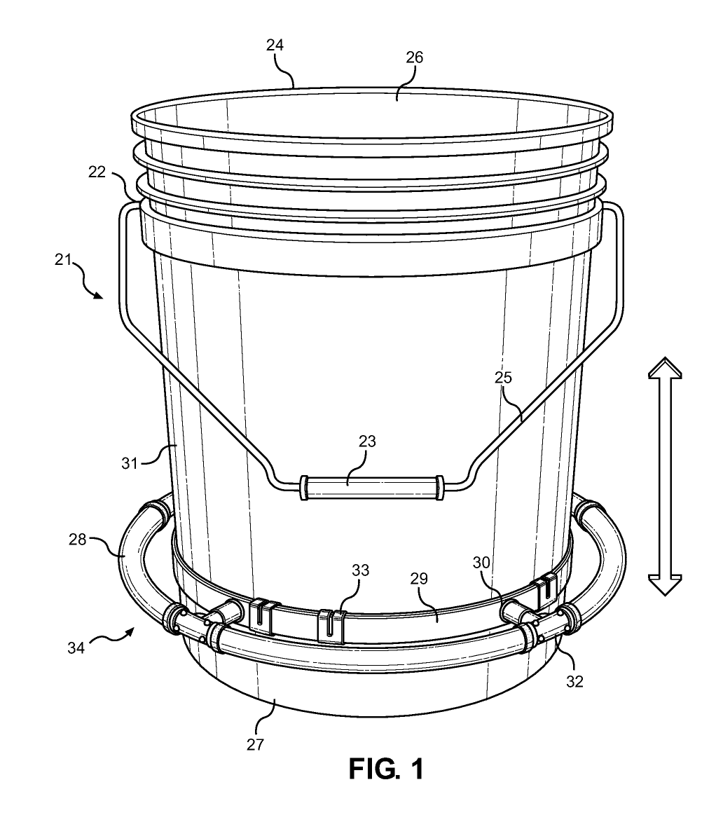

Referring now to FIG. 1, there is shown a front perspective view of the present invention. The present invention comprises a bucket 21 having an open upper end 24, a closed lower end 27, and an upstanding side wall 31 with a defined perimeter. The bucket 21 further comprises a hollow cavity 26 for carrying liquids, granular products, and other materials. In an exemplary embodiment, the bucket 21 is cylindrical in shape with a substantially circular cross section having a diameter that may vary along its height. The bucket 21 may be composed of metal, plastic, or other suitable materials that is resistant to rusting.

The bucket 21 comprises a bail handle 25 and a gripping portion 23 that are composed of metal, plastic, or other suitable material that is resistant to rusting. The bail handle 25 is curved so that it is substantially semicircular in shape and includes two terminal ends 22 that are pivotally attached on opposing sides of the upper end 24 of the bucket. In the exemplary embodiment, the bail handle 25 has a circular cross section with a diameter that is uniform throughout its length. The bail handle 25 comprises the gripping portion 23 at its substantial midpoint. The gripping portion 23 is a substantially cylindrical structure with a hollow middle that is adapted to maintain a portion of the bail handle 25 therein. The diameter of the cross section of the gripping portion 23 is larger than the diameter of the cross section of the bail handle 23 so that the gripping portion 23 can freely move about the bail handle 23. Additionally, the gripping portion 23 can rotate about a horizontal axis. In this way, a user does not need to adjust the grip of his or her hand on the gripping portion 23 when moving the position of the bail handle 25.

The bucket 21 further comprises an adjustable lifting assembly 34. The lifting assembly 34 includes a strap system that comprises a strap 29 with one or more adjusting mechanisms 33. The strap 29 is preferably composed of durable material such as nylon, polypropylene, cotton webbing, or other suitable webbed fabric material. The strap 29 is adapted to encircle the bucket 21 so that it tightly hugs the side wall 31 along its perimeter. The length of the strap 29 may be adjusted via an adjusting mechanism 33, which may be a clasp, buckle or the like. In this way, the user can adjust the length of the strap 29 to move the lifting assembly 34 up and down along the height of the bucket 21. Moving the lifting assembly 34 up and down the height of the bucket 21 allows the user to position the lifting assembly 34 at a location where it is most convenient and comfortable to the user.

The strap 29 is adapted to mount an annular handle to the bucket 21. The annular handle comprises a plurality of curved sections 28 that are connected to a plurality of joints 32 to form a ring-shape. The curved sections 28 are tubular and comprise a hollow interior that is adapted to receive an end of a joint at its terminal ends. The joints include a protruding end that is affixed to the strap 29 at attachment points 30 via a strong adhesive, fastener, or the like. The curved sections 28 and the joints 32 may be composed of rigid and durable material such as plastic, polyvinyl chloride (PVC), or the like.

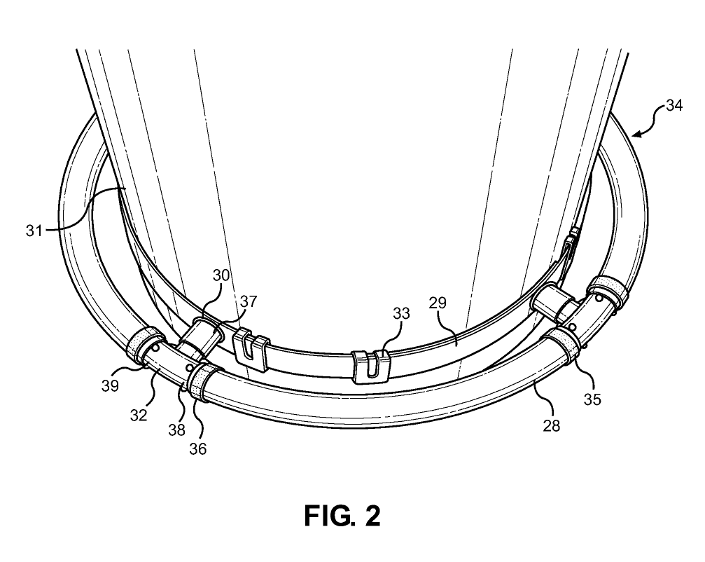

Referring now to FIG. 2, there is shown a close up view of the adjustable lifting assembly 34 of the present invention. The lifting assembly 34 comprises a strap system having a strap 29 and one or more adjusting mechanisms 33 that changes the length of the strap 29 and secures it in place. The strap 29 encircles the side wall 31 of the bucket so that it can affix the handle in place along the height of the bucket. In some embodiments, the strap 29 may include a high friction surface so that it does not easily slide or shift during use.

The annular handle comprises a plurality of curved sections 28 and a plurality of joints 32. Each of the curved sections 28 is tubular in shape and has a substantially circular cross section with a uniform diameter along its length. Each of the curved sections 28 comprises a first terminal end 35, a second terminal end 36, and a hollow interior. Each of the joints 32 comprises a first end 39 opposite a second end 38, and a protruding end 37 that extends at an angle perpendicular to the first end 39 and second end 38. In this way, each of the joints 32 has a generally T-shape. The first end 39 and second end 38 has a circular cross section with a diameter that is less than the diameter of the cross section of the curved sections 28.

When assembled, the first end 39 of the joint 32 is inserted into the first end 35 of a first curved section 28. Similarly, the second end 38 of the joint 32 is inserted into the second end 36 of a second curved section 28. The exact number of the joints 32 and curved sections 28 needed to form a complete ring-shape, however, is not of primary relevance with regard to the intent of the present invention, which portends to provide an improved configuration and positioning of the lifting assembly 34 along the height of the bucket on which it is mounted. The joints 32 and the curved sections 28 may be secured together via press fit, fasteners, or the like. Alternatively, the joints 32 and the curved sections 28 may include threaded elements so that each of the joints 32 and curved sections 28 may be screwed together. The joints 32 and the curved sections 28 are adapted to slightly flex as the strap 29 is adjusted in length. In this way, the annular handle can vary in diameter as it is positioned at various locations along the height of the bucket.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A combination bucket and adjustable lifting assembly, comprising:
a bucket having an open top end, a closed bottom end, and an upstanding wall having a perimeter;
wherein a distance between said top end and said bottom end defines a height;
a bail handle attached near said top end;
an adjustable lifting assembly having a strap system attached to an annular handle;
said strap system comprising a strap and at least one adjusting mechanism;
said annular handle secured to said strap via a plurality of joints;
said lifting assembly adapted to encircle said perimeter of said bucket;
said lifting assembly adapted to secure to said bucket at various locations along said height of said bucket.

2. The combination bucket and adjustable lifting assembly of claim 1, wherein said bail handle comprises:
a first and a second terminal end that is pivotally attached near said top end;
a gripping portion at a substantial midpoint of said bail handle.

3. The combination bucket and adjustable lifting assembly of claim 1, wherein said bucket is a cylinder with a substantially circular cross section.

4. The combination bucket and adjustable lifting assembly of claim 1, wherein said annular handle has a diameter greater than a diameter of said strap.

5. The combination bucket and adjustable lifting assembly of claim 1, wherein said least one adjusting mechanism is a clasp.

6. The combination bucket and adjustable lifting assembly of claim 1, wherein said annular handle comprises said plurality of joints connected to a plurality of curved sections.

7. The combination bucket and adjustable lifting assembly of claim 6, wherein said plurality of joints comprises a protruding end, a first end, and a second end;
said plurality of curved sections comprise a first end and a second end;
said first end of said plurality of joints connected to said first end of said plurality of curved sections;
said second end of said plurality of joints connected to said second end of said plurality of curved sections;
said protruding end of said plurality of joints connected to said strap.

8. The combination bucket and adjustable lifting assembly of claim 6, wherein said plurality of joints is substantially T-shaped.

9. The combination bucket and adjustable lifting assembly of claim 6, wherein said plurality of curved sections is a modified cylinder with a substantially circular cross section having a diameter.

10. The combination bucket and adjustable lifting assembly of claim 6, wherein said annular handle and said strap are concentric.

11. The combination bucket and adjustable lifting assembly of claim 6, wherein said annular handle and said strap are arranged in the same plane.

12. The combination bucket and adjustable lifting assembly of claim 6, wherein said joint is adapted to create a space between said annular handle and said strap such that a user can grasp said annular handle.
